(19) United States
(12) Patent Application Publication
(10) Pub. No.: US 2011/0262295 A1
(43) Pub. Date: Oct. 27, 2011

(54) Method for fabricating hard particle-dispersed composite materials

(76) Inventors: Oleg A. Voronov, East Stroudsburg, PA (US); Bernard H. Kear, Whitehouse Station, NJ (US)

(21) Appl. No.: 12/799,225

(22) Filed: Apr. 21, 2010

(51) Int. Cl. B32B 15/02; B22F 3/12

(52) U.S. Cl. 419/11; 419/10; 419/12; 419/13; 419/14; 419/19; 419/18; 75/230

(57) ABSTRACT

A method of making a hard particle-dispersed metal matrix-bonded composite, includes the steps of mixing hard particles and ductile metal particles to yield a mixture, and sintering the mixture under a pressure of less than 2.0 GPa and at a temperature of less than 1200° C. for a sufficient time to yield the composite. A composite material made by the above method is disclosed.

### GOVERNMENT INTEREST

This invention was made with government support under U.S. Department of Energy Contract No. DE-FG02-08ER85139 effective date Jun. 30, 2008-03/29/09. The government has certain rights in the invention.

### FIELD OF THE INVENTION

The present invention relates to composite materials, and more particularly, a method for fabricating hard particle-dispersed metal matrix-bonded (cemented) composites. The hard particles can be selected from carbides such as titanium carbide, nitrides, borides, silicides, oxides and/or diamond.

### BACKGROUND OF THE INVENTION

Hardmetals include a class of composite materials that are specifically designed to exhibit superior properties such as hardness (resistance to deformation), toughness (resistance to fracture), and wear resistance. Examples of hardmetals include cermets or sintered or cemented carbides such as cobalt cemented tungsten carbide (WC/Co). Cemented carbides, or metal matrix composites, generally comprise ceramic or carbide grains or particles (e.g., WC) as the aggregate bonded with binder metal particles (e.g., Co) as the matrix. Certain compositions of cemented carbide have been documented in the technical literature. For example, a comprehensive compilation of cemented carbide compositions is published in Brookes' World Dictionary and Handbook of Hardmetals, sixth edition, International Carbide Data, United Kingdom (1996).

Cemented carbides, such as WC/Co, exhibit desirable properties including hardness, wear resistance and fracture toughness suitable for broad applications such as cutting tools for cutting metals, stones, and other hard materials, mining tools for cutting coals and various ores and rocks, and drilling tools for oil and other drilling applications. Other applications include, but not limited to, protective coatings, wear parts, wire-drawing dies, knives, machine tools, drill bits, and armor. The cemented carbide is generally formed by first dispersing hard, refractory particles of carbides (e.g., WC) in a binder metal matrix (e.g., Co). Then the resulting mixture is cold pressed and sintered at low pressure (in vacuum) or sintered at high pressure (e.g., hot isostatic pressing (HIP)) for preparing a bulk composite. The mixture can also be thermally sprayed or welded onto the surface of a bulk metallic substrate for preparing functionally graded coating (e.g., cladding or hardfacing).

During this sintering process, the binder metal enters the liquid state and the carbide particles remain in the solid state. As a result of this process, the binder metal embeds or cements the carbide particles and then solidifies to yield the metal matrix composite with its distinct physical properties. The hard particles primarily contribute to the hard and refractory properties of the resulting cemented carbide. The naturally ductile metal serves to offset the characteristic brittle behavior of the carbide ceramic, thus enhancing toughness and durability. The physical properties can be changed by grain size, hard particle content, metal content, and degree of bonding between the hard particles and the metal matrix.

The hardmetal composite material of choice in nearly all applications is currently cobalt-cemented tungsten carbide (WC/Co), which is known and preferred for its high hardness, superior wear resistance and good fracture toughness. Recent improvements in WC/Co-based materials have been realized by the addition of diamond particles into the powder starting materials prior to pressure sintering. The addition of diamond particles yield C(diamond)/WC/Co composites.

C(diamond)/WC/Co composites exhibit excellent physical properties. During the fabrication process, it is known that diamond exhibits a tendency to undesirably transform into graphite at low pressure and high temperature. Diamond/WC/Co composites, thus, require extremely high sintering pressures to prevent the diamond particles from transforming into graphite as the raw materials consolidate into the final composite. In addition to high sintering pressure, the raw materials, tungsten and cobalt, are difficult to acquire since they must be imported from abroad and their availability is subject to foreign nations. These factors greatly affect the overall cost and complexity in making composites from such materials.

It is further known that WC/Co and diamond/WC/Co composites are especially susceptible to corrosion and corrosive wear. In sour-gas well drilling, for example, drill bits made from these composites experience disproportionate corrosive wear, which severely limits their useful life. As a result, there is an increase in “trip-time” associated with replacing the worn bit, which is both time-consuming and expensive. In geothermal wells, submersible pump bearings made from such composites are also exposed to severe corrosive wear which limits bearing lifetime, and hence increases overall operating costs.

Accordingly, there is a need for a method for making a hard particle-dispersed composite material that confers advantages over conventional cemented carbide composites. There is a further need to provide a method for making a hard particle-dispersed composite material that is super-hard, lightweight and corrosion resistant at more economical processing pressures and temperatures. There is a further need to provide a method for the making a hard particle-dispersed composite material that is more cost effective and simpler to fabricate for various applications.

### SUMMARY OF THE INVENTION

The present invention relates generally to a method for the making a hard particle-dispersed composite material, and preferably a titanium carbide- and/or a carbon in diamond phase-dispersed composite material. The composite material produced by the method of the present invention exhibits desirable properties including high hardness, superior wear resistance, good fracture toughness and excellent corrosion resistance, while being simpler and more cost efficient to fabricate than prior art composite materials of similar properties. The method of the present invention have been found to afford considerable flexibility in tailoring the properties of the resulting composite material suitable to meet a range of performance requirements for different applications. The method of the present invention utilizes existing materials and commercially available equipment, and reduces the time and cost needed for production.

The composite materials of the present invention are fabricated from a mixture of metal or ductile particles and hard particles including metal carbide such as titanium carbide, and/or diamond particles. The composite materials of the present invention can be produced by different methods including, but not limited to, pressure assisted sintering, or by thermal spraying or weld overlaying, or by pressure assisted extrusion, but examples for the present invention as provided below describe the method using pressure-assisted sintering. Prior to pressure-assisted sintering, the mixture can be pressed together at room temperature. The mixture undergoes pressure-assisted sintering under elevated pressures and at elevated temperatures for a predetermined holding time. While maintaining the sintering pressure, the resulting composite is thereafter cooled.

The resulting composite can be heat treated at high temperatures and under low pressure in the presence of an inert gas such as argon. The hard particles can also be selected from carbides, borides, nitrides, silicides, oxides, and/or carbon in diamond phase, (“C(diamond)” or “C(d)”). A preferred composition of the present invention includes a combination of carbon (C) and titanium (Ti) to yield TiC/Ti, and C(d)/Ti and/or C(d)/TiC/Ti. The metal particles can be selected from titanium, aluminum, beryllium, and alloys thereof. Preferably, the metal is titanium and titanium alloys.

In one aspect of the present invention, there is provided a method of making a hard particle-dispersed metal matrix-bonded composite, which comprises the steps of:

mixing hard particles and ductile metal particles to yield a mixture thereof; and

sintering the mixture under a pressure of less than 2.0 GPa and at a temperature of less than 1200° C. for a sufficient time to yield the composite.

In another aspect of the present invention, there is provided a composite produced by the method above.

### BRIEF DESCRIPTION OF THE DRAWINGS

The following drawings are illustrative of embodiments of the present invention and are not intended to limit the invention as encompassed by the claims forming part of the application.

FIG. 1 is a flow chart illustrating the steps of a method for making a composite material in accordance with one embodiment of the present invention;

FIG. 2 is a flow chart illustrating the steps of a method for making a composition material in accordance with a more preferred embodiment of the present invention;

FIG. 3 is a representative photo-micrograph at 400× magnification of the surface of a diamond/TiC/Ti composite material in accordance with one embodiment of the present invention;

FIG. 4 is a cross sectional view of a functionally graded composite material for one embodiment of the present invention;

FIG. 5 is a pressure vs. temperature graph showing pressure-temperature ranges for fabricating diamond-hardfaced composites of the prior art in comparison to the composite materials in accordance with the present invention; and

FIG. 6 is a schematic diagram of a high-pressure and high temperature (HPHT) apparatus or system suitable for use in preparing the composite materials of the present invention.

### DETAILED DESCRIPTION OF THE INVENTION

The present invention directed generally to a method for the making a hard particle-dispersed metal matrix-bonded (cemented) composite material. The composite material produced by the method of the present invention exhibits desirable properties including high hardness, superior wear resistance, good fracture toughness and corrosion resistance, while being simpler and more cost efficient to fabricate than prior art composite materials of similar properties. The methods of the present invention have been found to afford considerable flexibility in tailoring the properties of the resulting composite material suitable to meet a range of performance requirements for different applications. The method of the present invention utilizes existing materials and commercially available equipment, and reduces the time, temperature requirements, and cost needed for production.

In accordance with one embodiment of the present invention, there is provided a method for making the composite materials of the present invention. A mixture of metal particles and hard particles such as metal carbide particles and/or diamond particles are prepared. The components of the mixture may be homogenous and uniformly dispersed or functionally graded. Optionally, the mixture can be pressed together at room temperature to yield a preform having increased apparent density prior to forming the final composite.

The mixture then undergoes pressure-assisted sintering under elevated pressures and at elevated temperatures for a predetermined holding time. While maintaining the sintering pressure, the resulting composite is cooled to ambient temperature. The mixture of metal particles and hard particles such as diamond particles and/or metal carbide particles (e.g., titanium carbide) can be graded over varying volume percent ratios from one region to another to yield a functionally graded composite material.

In accordance with a preferred embodiment of the present invention, the metal particles are selected from titanium, aluminum, beryllium, and alloys thereof. Preferably, the metal particles are selected from titanium and alloys thereof. The average particle or grain sizes of the metal particles are at least 10 μm, and preferably from about 10 μm to 50 μm.

In accordance with a preferred embodiment of the present invention, the hard particles are selected from carbides, borides, nitrides, silicides, oxides, and/or diamond. Preferably the hard particles are selected from diamond, metal carbides such as titanium carbide, and combinations thereof. The average particle or grain sizes of the hard particles selected carbides, borides, nitrides, silicides, and oxides are at least 50 nm, and preferably from about 1 to 2 μm. The diamond particles (C(d)) can be selected from monocrystalline diamond grains, polycrystalline diamond grains, and combinations thereof. Preferably, the diamond particles are selected from polycrystalline diamond grains. The average particle or grain sizes of the diamond particles are at least 5 μm, and preferably from about 50 μm to 500 μm.

The mixture is pressed together under pressure of about 0.5 GPa and at about room temperature (i.e., 18° C. to 28° C.) to produce a compact, green body or preform. The compact undergoes pressure-assisted sintering under pressures of about less than 2.0 GPa, and at temperatures, of about less than 1200° C. for a predetermined holding time of about 1 to 15 minutes. While maintaining the sintering pressure, the resulting composite is thereafter cooled to about room temperature.

The term “homogenous and uniformly dispersed” is intended to refer to a characterization of the composite material of the present invention in which the composition and structure is substantially the same throughout the composite as homogenous mixtures.

The term “functionally graded” is intended to refer to a characterization of the composite material of the present invention in which the composition and structure vary gradually over volume, resulting in corresponding changes in properties of the material. Generally, the location, volume fraction and compositional gradient of the individual material components (i.e., metal matrix and hard particles) can be varied within the mixture in preparation for pressure-assisted sintering to yield the composite material of the present invention as a functionally graded material. For example, two or more components are blended during forming and the ratio is continuously varied over a specified volume from 100% of component 1 through to 100% of component 2 (or variation thereof).

Various approaches as known in the art can be used to fabricate the present composite materials into the form of functionally graded materials. Examples of such approaches include, but are not limited to, bulk (particulate processing), controlled-blend processing (impeller dry blend processing), controlled-segregation processing, preform processing, layer processing and melt processing. Such processing techniques for producing functionally graded materials are generally known to one skilled in the art.

The starting powders are produced by any known suitable processes including, but not limited to, inert gas atomization (metal powders), carbothermic methods (carbide powders) and the like.

Examples of methods for preparing the starting material before pressure-assisted sintering include ball mill mixing, thermal spraying, plasma spraying, flame spraying and the like. Thermal spray technology includes both plasma spraying and flame spraying. In plasma spraying, an aggregated titanium carbide/titanium-base powder is fed at a controlled rate into a plasma stream, where the titanium-base particles melt and wet the un-melted titanium carbide particles to form semi-solid or “mushy” particles, which then impact on the substrate to form a relatively dense coating. The as-sprayed coating consists of a uniform dispersion of hard titanium particles in a titanium-base matrix phase. Some dissolution of the titanium carbide particles in the liquid titanium occurs, depending on the degree of superheat of the melted particles.

The coating builds up by the superposition of “splat-quenched” mushy particles and has a characteristic micro-laminated structure. To mitigate decarburization of the titanium carbide particles during plasma spraying in ambient air, various strategies can be used, such as inert-gas shrouding or reducing the enthalpy of the plasma. The latter approach is simplest to implement. Typical operating parameters are given in Table 1 for air plasma spray systems (APS).

TABLE 1
Examples of APS thermal spray parameters

| Deposition System | Ar/He plasma | N₂H₂ plasma |
|---|---|---|
| Gun | Metco 9MB | Metco 3MB |
| Gas type | Argon/He | N₂/H₂ |
| Gas pressure (kPa) | 689/689 | 344.5/344.5 |
| Current (A) | 500 | 600 |
| Voltage (V) | 70-75 | 70-75 |
| Spray distance (cm) | 7.5 | 7.5 |
| Spray rate (kg/h) | 3.64 | 2.275 |

In flame spraying, in its most advanced form called high velocity oxy-fuel (HVOF) spraying, the processing methodology is similar. However, because of the much reduced enthalpy of a combustion flame, it is easier to avoid overheating the aggregated feed powder, so that decarburization of the titanium carbide component is minimized. Another positive feature of HVOF spraying is the high velocity of the gas stream with its entrained particles. Upon impact with the substrate, a high density coating with minimal decarburization is formed. Typical operating parameters are given in Table 2.

TABLE 2
Example of HVOF thermal spray parameters

| | |
|---|---|
| Deposition System | HVOF |
| Gun | Metco DJ |
| Gas type | Oxygen/propane/air |
| Gas pressure (kPa) | 689/689/617-551 |
| Gas flow (m³/h) | 16.34/4.98/24.27 |
| Spray distance (cm) | 15-20 |
| Spray rate (kg/h) | 2.27 |
| Nozzle | #2 injector and shell, |
| | inserts V4 |

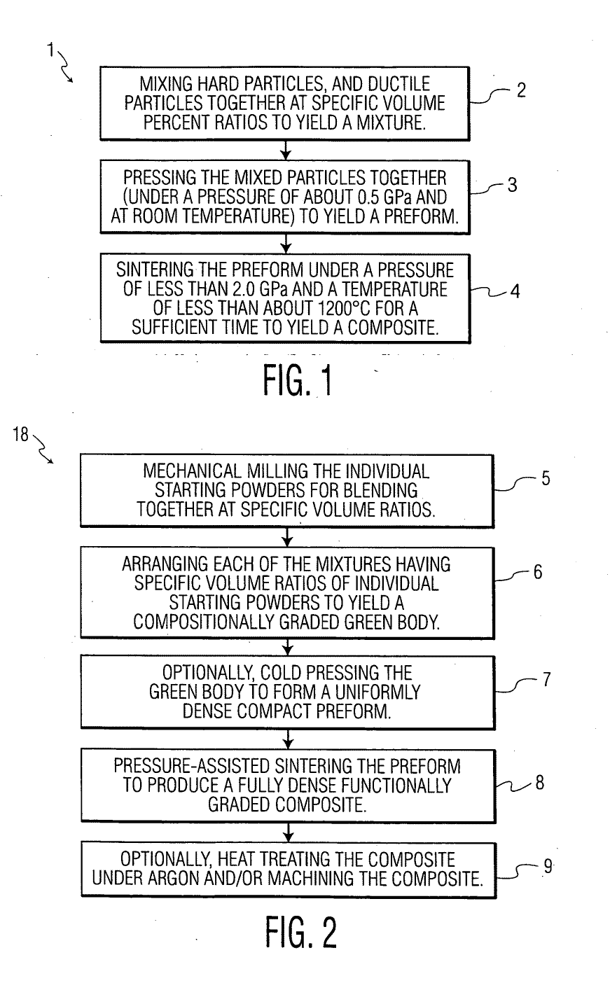

Referring to FIG. 1, a method for fabricating a hard particle-dispersed metal matrix-bonded (cemented) composite material, the method identified generally by reference numeral 1, is shown for one embodiment of the present invention. The method 1 of the present invention includes a step 2 of mixing particles of hard material and metal or ductile material. The hard particles can be selected from carbides including metal carbides such as titanium carbide, borides, nitrides, silicides, oxides, diamond, and combinations thereof. Preferably, the hard particles are selected from carbides such as titanium carbide, diamond and combination thereof. The diamond particles can be any diamond powder including, but not limited to, monocrystalline diamond grains, polycrystalline diamond grains, and combinations thereof. The metal or ductile particles can be selected from titanium, aluminum, beryllium, and alloys thereof. Preferably, the metal particles are selected from titanium and alloys thereof.

The hard particles can also be selected from other carbides including WC, SiC, Cr₃C₂, and B₄C, borides including WB₄, TiB₂, AlB₁₂, and HfB₂, nitrides including BN (hard cubic phase), Si₃N₄, TiN, and ZrN, silicides including B₄Si, Ti₅Si₃, and TiSi, TiSi₂, and oxides including BeO, Al₂O₃, SiO₂, and TiO₂, and combinations thereof. The starting materials (e.g., titanium carbide, diamond and titanium) are produced by any known suitable processes including, but not limited to, inert-gas atomization, carbothermic methods, and the like. The combination of the components of the mixture can be compositionally graded in varying volume ratios of each to yield a functionally graded composite.

In one preferred embodiment of the present invention, the volume fractions of the constituent phases of hard particles (diamond and titanium carbide) and metal particles (titanium), respectively, are given as follows.

Examples of vol. % of TiC/Ti mixtures in top layer (hardfacing layer): 90%, 75%, 70%, 60%, 50%;

Examples of vol. % of C(diamond)/Ti mixtures in top layer (hardfacing layer): 75%, 70%, 60%, 50%, 40%, 30%;

Grain sizes of diamond particles: 500 μm (600/400), 50 μm (60/40), 5 μm (5/3);

Examples of mixtures of diamond particles: (1)[500 μm (600/400), 75 wt. %+50 μm (60/40), 25 wt. %]; (2)[50 μm (60/40), 75 wt. %+5 μm (7/5), 25 wt. %]; (3)[500 μm (600/400), 68 wt. %+50 μm (60/40), 23 wt. %+5 μm (5/3), 9 wt. %];

Grain sizes of TiC particles: 2 μm or 50 nm (80/50); and

Grain sizes of Ti (or alloy) particles: 50 μm (60/40), or 10 μm.

In step 3, a homogenous or functionally-graded green body that is relatively solid, but weak and not machinable due to fragility is prepared. The mixture, which can be a homogenous mixture or a compositionally graded mixture, is cold pressed or compressed together under pressure, preferably less than 0.5 GPa, and at about ambient or room temperature. The cold pressed mixture results in a uniformly dense mass or preform, or a green body, which is a weakly bound and fragile solid that is not machinable. In step 4, the preform is subjected to pressure-assisted sintering under elevated pressures and temperatures for a sufficient time. The elevated pressure is preferably less than 2.0 GPa, and more preferably from about 0.2 GPa to 2.0 GPa. The elevated temperature is preferably less than 1200° C., and more preferably from about 700° C. to 1200° C. The temperature is typically about 700° C. for titanium, beryllium and alloys thereof, and about 500° for aluminum and alloys thereof. The time for the pressure-sintering step depending on the temperature, can be from about 1 to 15 minutes.

The diamond particles are incorporated into the present composite material to provide enhanced hardness characteristics for especially demanding applications such as, for example, rock drill bits or slide bearing surfaces. The interface of the composite material can be compositionally graded to further enhance resistance against wear and thermal and elastic misfit stresses, thus minimizing coating/substrate delamination or spallation during use. In this manner, the pressure, temperature, time and concentration of the components can be adjusted to achieve variable properties and performance. Increasing the volume fraction of the hard particles enhances the hardness of the composite material, while increasing the volume fraction of metal particles enhances the crack or fracture resistance of the composite material.

In reference to FIG. 2, a method for fabricating a hard particle-dispersed composite material, the method identified generally by reference numeral 18, is shown for another embodiment of the present invention. Preferably, the composite material is C(d)/TiC/Ti. The method 18 includes a step 5 of mechanically milling the individual starting materials or components in varying volume ratios to produce individual mixtures. In step 6, the individual mixtures are arranged relative to one another by varying volume ratios of the components to yield a compositionally graded mass or bulk. In optional step 7, the compositionally graded mass or bulk is cold pressed under pressure of less than 0.5 GPa and at about room (ambient) temperature (e.g., about 18° C. to 28° C.) to form a uniformly dense green body (preform). In step 8, the preform undergoes pressure-assisted sintering under the conditions of pressure and temperature described above to yield a fully dense functionally graded composite material. In step 9, the composite material can optionally be machined, or heat treated under low pressure in the presence of an inert gas such as argon and machined thereafter.

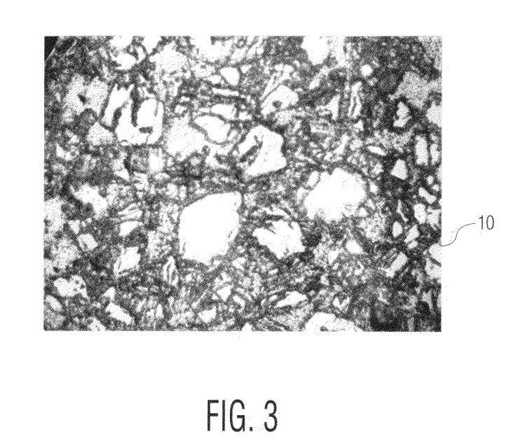

Referring to FIG. 3, a representative photo-micrograph at 400× magnification of the surface of a diamond/titanium carbide/titanium composite material (C(d)/TiC/Ti) in accordance with one embodiment of the present invention is shown.

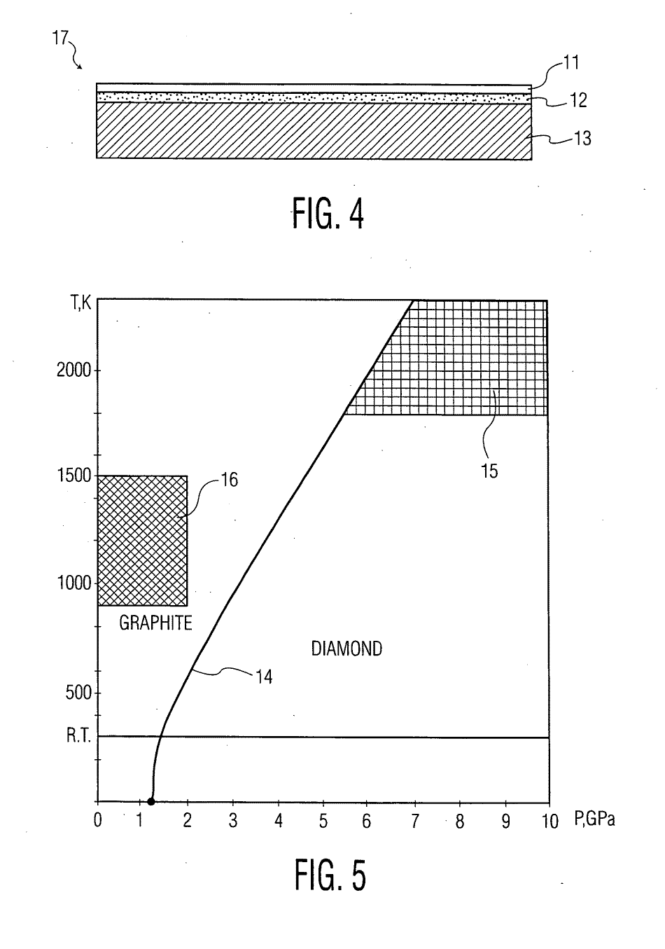

Referring to FIG. 4, a cross sectional view of a functionally graded composite material 17 for one embodiment of the present invention. The functionally graded diamond/titanium carbide/titanium composite material (C(d)/TiC/Ti) 17 is composed of a diamond/titanium hardface region 11 wherein the concentration of diamond is maximum at the surface and the concentration of the titanium metal is maximum at the bottom side thereof, a graded diamond/titanium carbide/titanium middle region 12, and a graded titanium carbide/titanium substrate region 13. The structure is functionally graded.

The diamond particles are dispersed in the titanium metal (a binder) primarily on a top surface of the region 11 where superhardness is needed. The concentration of the diamond particles decreases toward bottom of region 11. The concentration of titanium carbide particles in the graded diamond/titanium carbide/titanium middle region 12 is greater under region 11 where higher hardness is needed, and the concentration of titanium carbide is maximal at the top of graded titanium carbide/titanium substrate region 13 where high hardness is needed. The concentration of the titanium carbide particles in region 13 decreases to zero toward its bottom where high impact strength and resistance to cracking are needed.

In one embodiment of the present invention, region 11 is composed of diamond in an amount of 50 volume percent and titanium in an amount of 50 volume percent, each based on the total volume of region 11. Region 12 is composed of diamond in an amount of 25 volume percent, titanium carbide in an amount of 25 volume percent, and titanium in an amount of 50 volume percent, each based on the total volume of region 12. Region 13 is composed of titanium carbide in an amount of 50 volume percent, and titanium in an amount of 50 volume percent, each based on the total volume of the hard-faced portion of region 13, and titanium in an amount of 100 volume percent, based on the total volume of the ductile bottom portion of region 13. The diamond particles can be uniformly dispersed throughout the regions 12 and 13, if needed.

Referring to FIG. 5, a pressure vs. temperature graph showing pressure-temperature ranges is shown for fabricating diamond-hardfaced composites of the prior art in comparison to the composite materials in accordance with the present invention. The curve 14 indicates the equal thermodynamic potential between diamond and graphite for hard phase (diamond) stability. The temperature-pressure region 15 corresponds to sintering conditions required for diamond-cobalt (C—Co, Ni, Fe) alloy composites using conventional industrial methods, while the temperature-pressure region 16 represents the sintering conditions of the methods of the present invention. As shown clearly, the temperature and pressure conditions represented by region 16 necessary to fabricate the composite materials of the present invention are significantly lower than the conditions required for making prior art composite materials.

As previously indicated for FIG. 5, the curve 14 is the line of equal thermodynamic potential for graphite and diamond. The region 15 is the region where C(d)/Co or C(d)/WC/Co composites are processed by known industrial methods, and the region 16 is the region where C(d)/Ti or C(d)/TiC/Ti composites are processed by the present method. The fact that C(d)/Ti and C(d)/TiC/Ti composites can be consolidated at lower pressures and temperatures, relative to that for C(d)/Co and C(d)/WC/Co, is a definite advantage, since there is no reasonable practical limit to sizes and shapes of parts or components that can be fabricated. In other tests, the feasibility of compositionally grading the interface between the diamond hardfacing and the TiC/Ti substrate has been demonstrated. The graded C(d)/TiC/Ti is resistant to delamination under thermal cycling conditions.

Vickers hardness measurements have shown that for comparable volume fractions of carbide phase, TiC/Ti by this method has higher hardness than known industrial composites based on WC/Co, Cr. Toughness and impact strength of TiC/Ti are also greater at the higher hardness.

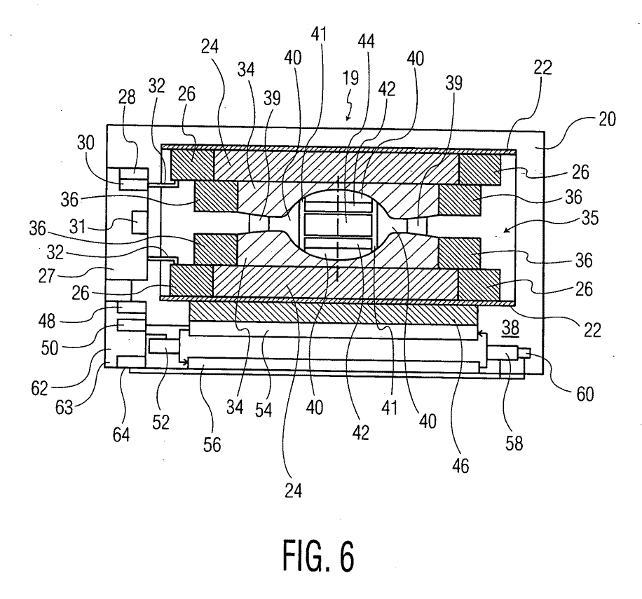

FIG. 6 shows a schematic example of a high pressure and high temperature system or apparatus 19 suitable for preparing the composite materials of the present invention. The apparatus 19 includes a hydraulic unit (HU) 38, a high pressure unit (HP) 35, a container unit (CU) 40, a reaction cell (RC) 42, a power supply (PS) 27, and an electronic control unit (EC) 62. The hydraulic unit 38 includes a frame 20 housing the high pressure unit 35, a hydraulically driven working cylinder 54 and ram 46. The cylinder 54 and ram 46 are driven via pumps 58 and 60 in connection with an oil tank 56 and valve 52. The high pressure unit includes opposing first and second inner anvils 34 in operative engagement with corresponding steel rings 36, opposing first and second insulating layers 22, and opposing bearing discs 24 in operative engagement with corresponding steel rings 26 disposed between the insulating layers 22 and anvils 34.

The container unit 40 is composed of clay material surrounding the reaction cell 42, and further includes a deformable ring 39 extending therearound. The container unit 40 and the deformable ring are each disposed between the anvils 34. The reaction cell 42 includes a graphite heater 41 extending around a sample 44. The high pressure unit 35 retains and squeezes the container unit 40 with the reaction cell 42 between the anvils 34. The anvils 34 are supported via the steel rings 36.

The loading force is applied to the anvils 34 from ram 46 and frame 20 through the bearing discs 24. The bearing discs 24 are supported via the steel rings 26. The reaction cell 42 is adapted to hold the sample 44, which is in the form of a green body (homogenous or functionally graded mixture of powders) used to make the composite material of the present invention. The cylinder 54 and ram 46 generates the necessary force on the high pressure unit 35 to compress the container unit 40. The container unit 40 comprises a clay-sand mixture or a suitable electrically non-conductive material, and the reaction cell 42.

The power supply 27 includes copper cables 32 connected to the graphite heater 41, a shunt 30, and voltage and current meters 28 and 31. An electrical current is supplied to the reaction cell 42 via a power supply (PS) 27 to generate the heat energy needed to raise the temperature of the reaction cell 42. Insulating layers 22 are provided between the frame 20 and the cylinder 54 and ram 46 of the hydraulic unit 38 for electrical insulation. The electronic control unit 62 includes a processor 63, a timer 48, a pressure gage 50, and electrical motors 64 for driving the pumps 58 and 60. It will be understood that the control devices and electrical components are suitably arranged as known in the art to accurately provide the proper control and programming of the pressure and temperature over time needed to yield the composite materials of the present invention.

The design of the high pressure and high temperature apparatus 19 is similar to the HPHT apparatus as taught in Voronov (U.S. Pat. No. 6,942,729), the content of which is incorporated herein by reference, but is simplified for moderate (lower) pressure and temperature ranges that are used in the present invention. The design of the apparatus described in Voronov is more complicated, since it was invented to generate very (extremely) high static pressure and temperature in relatively large volume. When such a high pressure and high temperature are not needed the Voronov apparatus can be simplified and adjusted for moderate ranges as shown in system 19. The last modification is very economical and technically viable for industrial applications.

### EXAMPLES

### Example 1

The hardness and density properties of titanium carbide/titanium composites of the present invention are listed below in Table 3.

TABLE 3
Hardness and density of TiC/Ti samples sintered at P = 1.9
GPa, T = 700-1100° C., t = 1.5-15 min. holding time

| | Comp. of | Hardness of | Hardness of | Hardness of | Density of |
|---|---|---|---|---|---|
| | Carbide-Metal | Carbide-Metal | Carbide-Metal | Diamond-Metal* | Carbide-Metal |
| | Part of Sample, | Surface | Surface on | Surface on | Part of |
| No | (weight %) | HV1 (GPa) | Mohs scale | Mohs Scale | Sample |
| 1 | TiC91Ti9 | 20.2 | ~9 | 10 | 4.8 |
| 2 | TiC77Ti23 | 24.4 | ~9½ | 10 | 4.8 |
| 3 | TiC52Ti48 | 9.0 | ~7 | 10 | 4.7 |
| 4 | TiC50Ti50 | 11.7 | ~7½ | 10 | 4.7 |
| 5 | TiC50Ti45Al3V2 | 18.9 | ~9 | 10 | 4.7 |
| 6 | TiC90Ti7.5Cu2.5 | 19.5 | ~9 | 10 | 4.9 |
| 7 | TiC74Ti20Cu6 | 24.3 | ~9 | 10 | 4.9 |

### Example 2

A comparison of the density and hardness properties of different hard particle-dispersed composites are provided in Table 4 below.

TABLE 4
Properties of composites

| | Density, | Hardness | |
|---|---|---|---|
| Composite | g/cm³ | HV, GPa | Remarks |
| WC/Co | 13.66-15.02 | 9.0-13.1 | Industrial |
| WC/CoCr | 13.14-14.85 | 11.5-13.9 | Reported |
| TiC/Ti | 4.71-4.81 | 9.0-24.4 | Present |
| C(d)/TiC/Ti | 3.92-4.32 | 30-60 | invention |

### Example 3

A comparison of sliding coefficients of diamond-hardfaced composites and carbide-hardfaced composites is shown in Table 5 below.

TABLE 5
Sliding friction coefficients of diamond-hardfaced
composites (DHC) and carbide-hardfaced composites
(CHC) (against type 304 steel): dry and in brine.

| | Dry | | In brine | |
|---|---|---|---|---|
| | | (In motion | | (In motion |
| | (In rest) | v ~0.5 | | v ~0.5 |
| Material | K_{R} | m/s) K_{M} | K_{R} | m/s) K_{M} |
| C(d)/TiC/Ti | 0.05-0.10 | 0.10-0.13 | 0.10-0.12 | 0.05-0.10 |
| Hardfacing | | | | |
| WC/Co | 0.10-0.11 | 0.11-0.14 | 0.17-0.21 | 0.20-0.24 |
| Hardfacing | | | | |

(Load F = 1N/slider)

### Example 4

A comparison of the wear resistance of various materials is shown in Table 6 below.

TABLE 6
Comparison of spherical (Ø¼″) sliders (pin: R = 3.175 mm) wear under load
of 1 kgf/slider, v = 0.50 m/s

| | | | Radius of | Linear | | Volume | |
|---|---|---|---|---|---|---|---|
| Material | Density, | Hardness, | worn | wear, | dh/dt, | wear, | dV/dt, |
| of pin | mg/mm³ | HV, GPa | area, mm | mm | μm/min | mm³ | mm³/min |
| Teflon | 2.16 | — | 2.23 | 0.915 | 91.5 | 7.549 | 9.15 |
| Brass | 8.51 | 2.1 | 2.61 | 1.367 | 136.7 | 15.964 | 13.67 |
| Ti | 4.45 | 3.6 | 2.55 | 1.283 | 128.3 | 14.207 | 12.83 |
| Steel | 7.63 | 8.2 | 0.70 | 0.078 | 7.8 | 0.060 | 0.0060 |
| 440 C. | | | | | | | |
| WC/Co6% | 14.95 | 18.5 | 0.34 | 0.018 | 1.8 | 0.003 | 0.0003 |
| C(d)/TiC/Ti | 3.51 | 75 | 0.00 | 0.000 | 0.0 | 0.000 | 0.0000 |

### Example 5

Test pieces of diamond-hardfaced carbide/metal composites (or carbide-hardfaced carbide/metal composites) and experimental bearing components can be fabricated by the following multi-step process:
1. Making profiled graphite ceramic crucibles;
2. Mechanical milling to mix the starting powders;
3. Cold pressing to obtain uniformly dense “green bodies”, with graded diamond layers;
4. High-pressure sintering to generate fully dense graded-composite components;
5. Diamond machining and polishing to obtain sliding-thrust bearings; and
6. Assembling the finished bearings for rig testing.

This process can be used to make experimental components of the new composite bearings for submersible pumps in geothermal wells and other applications.

### Example 6

A step by step protocol used to make the present TiC/Ti composite material is provided below.
Making profiled graphite ceramic crucibles;
Mechanical milling to mix the TiC and Ti alloy starting powders;
Cold pressing to obtain uniformly dense “green bodies” (P₀=0.5 GPa; T₀=RT);
High-pressure sintering (P=1.9 GPa, T=900° C., t=15 min.) to generate fully dense TiC/Ti composite components;
Diamond machining (machining by diamond tools) and polishing to obtain sliding-thrust bearings;
Assembling the finished bearings for rig testing.

### Example 7

A step by step protocol used to make the present functionally graded (FG) TiC/Ti composite material is provided below.
Making profiled graphite ceramic crucibles;
Mechanical milling to mix the Ti alloy powder; TiC powder and Ti alloy starting powders with different concentration of TiC and Ti; pouring into graphite crucible for FG distribution of components;
Cold pressing to obtain uniformly dense FG “green bodies” (P₀=0.5 GPa; T₀=RT);
High-pressure sintering (P=1.9 GPa, T=900° C., t=15 min.) to generate fully dense FG TiC/Ti composite components;
Diamond machining and polishing to obtain sliding-thrust bearings;
Assembling the finished bearings for rig testing.

### Example 8

A step by step protocol used to make the present Diamond/TiC/Ti composite material in a functionally (compositionally) graded form is provided below.
Making profiled graphite ceramic crucibles;
Mechanical milling to mix the Diamond powders and Ti alloy powder; TiC powder and Ti alloy starting powders with different concentration of Diamond/Ti and TiC/Ti; pouring into graphite crucible for FG distribution of components;
Cold pressing to obtain uniformly dense FG “green bodies” (P₀=0.5 GPa; T₀=RT);
High-pressure sintering (P=1:9 GPa, T=900° C., t=15 min.) to generate fully dense FG Diamond/TiC/Ti composite components;
Diamond machining and polishing to obtain sliding-thrust bearings;
Assembling the finished bearings for rig testing.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

1. A method of making a hard particle-dispersed metal matrix-bonded composite, comprising the steps of:
mixing hard particles and ductile metal particles to yield a mixture thereof;
forming a container surrounding a reaction cell, said reaction cell comprising an electrical resistive heater;
placing said mixture into said container with said heater extending around said mixture;
placing said container with the mixture into a high pressure high temperature apparatus;
compressing the container and mixture via said apparatus for applying a pressure of less than 2.0 GPa;
passing an electric current through the heater for heating the mixture to a temperature of less than 1200° C., while maintaining the pressure, to sinter the mixture for a sufficient time to yield the composite;
terminating the heating of said composite; and
cooling the composite in said apparatus while maintaining the sintering pressure, until the composite cools to about room temperature.

2. The method of claim 1, wherein the metal particles are selected from the group consisting of titanium, aluminum, beryllium, and alloys thereof.

3. The method of claim 1, wherein the hard particles are selected from the group consisting carbides, borides, nitrides, silicides, oxides, carbon (in diamond phase), and combinations thereof.

4. The method of claim 3, wherein the hard particles is selected from the group consisting of titanium carbide, carbon (in diamond phase), and combinations thereof.

5. The method of claim 1, further comprising the step of compressing or pressing the mixture together prior to sintering.

6. The method of claim 5, wherein the mixture is pressed under a pressure of less than 0.5 GPa and at room temperature of from about 18° C. to 28° C.

7. The method of claim 1, wherein the sintering pressure ranges from about 0.2 GPa to 2.0 GPa.

8. (canceled)

9. The method of claim 3, wherein of the diamond particles have an average particle size of at least 5 μm.

10. The method of claim 9, wherein the average particle size of the diamond particles ranges from about 50 μm to 500 μm.

11. The method of claim 1, wherein the metal particles have an average particle size of at least 10 μm.

12. The method of claim 1, wherein the metal particles have an average particle size in the range of from about 10 μm to 50 μm.

13. The method of claim 1, wherein the hard particles have an average particle size of at least 50 nm.

14. The method of claim 13, wherein the average particle size of the hard particles ranges from about 1 μm to 2 μm.

15. The method of claim 1, wherein the mixture is homogenous and uniformly dispersed.

16. The method of claim 1, wherein the mixture is functionally graded.

17. The method of claim 3, wherein the diamond particles are selected from the group consisting of monocrystalline diamond grains, polycrystalline diamond grains, and combinations thereof.

18. (canceled)

19. A composite made by a process of claim 1.
